(19) United States
(12) Patent Application Publication
(10) Pub. No.: US 2026/0291401 A1
(43) Pub. Date: Sep. 24, 2026

(54) AC-TO-DC CONVERTER WITH INTELLIGENT CAPACITIVE ENERGY STORAGE REGULATOR

(71) Applicant: Amber Semiconductor, Inc., Dublin, CA (US)

(72) Inventors: Mark Telefus, Orinda, CA (US); Harry Rodriguez, San Jose, CA (US); Suhail Zain, San Ramon, CA (US)

(21) Appl. No.: 19/478,165

(22) PCT Filed: Apr. 26, 2024
(86) PCT No.: PCT/US2024/026577

§ 371 Date: Oct. 23, 2025

Related U.S. Application Data
(60) Provisional application No. 63/462,376, filed on Apr. 27, 2023.

(51) Int. Cl. H02M 7/217; H02M 1/00

(52) U.S. Cl. CPC H02M 7/217; H02M 1/0006

(57) ABSTRACT

A power converter comprises a first solid-state switch connected between first and second nodes, a storage capacitor coupled between the second node and a ground node, and a control system configured to control charging of the storage capacitor. The control system is configured to: determine a voltage level across the storage capacitor; activate the first solid-state switch during a given positive half-cycle of AC power applied to the first node to allow current to flow from the first node to the second node to charge the storage capacitor, in response to determining that the voltage level across the storage capacitor is less than a minimum voltage level; and deactivate the first solid-state switch during the given positive half-cycle of the AC power, in response to determining that the voltage level across the storage capacitor has reached a maximum voltage level.

### CROSS-REFERENCE TO RELATED APPLICATION

This application claims the benefit of U.S. Provisional Application Ser. No. 63/462,376, filed on Apr. 27, 2023, the disclosure of which is incorporated herein by reference.

### BACKGROUND

This disclosure relates generally to power conversion techniques and, in particular to power conversion techniques for converting alternating current (AC) power to direct current (DC) power. Conventional approaches for converting AC power to DC power employ various analog circuitry to achieve AC-to-DC voltage conversion. For example, one type of conventional AC-to-DC converter includes a transformer-based linear converter which utilizes a simple diode bridge, capacitor, and a voltage regulator, wherein the diode bridge is constructed using four independent diodes. Another type of conventional converter implements a switch mode power supply architecture which utilizes a small high-frequency transformer and a switching regulator to provide a DC voltage output. However, such conventional power conversion approaches undesirably require many circuit components which may cause signal processing delay, inaccuracy, and/or overall increased cost to implement AC-to-DC converters.

### SUMMARY

Exemplary embodiments of the disclosure include power converters and techniques for converting AC power to DC power.

For example, an exemplary embodiment includes a power converter which comprises a first solid-state switch, a storage capacitor, and a control system. The first solid-state switch is connected in an electrical path between a first node and a second node. The storage capacitor is coupled between the second node and a ground node. The control system is configured to control a charging of the storage capacitor, wherein the control system is configured to: determine a voltage level across the storage capacitor; activate the first solid-state switch during a given positive half-cycle of AC power applied to the first node to allow current to flow from the first node to the second node to charge the storage capacitor, in response to determining that the voltage level across the storage capacitor is less than a minimum voltage level; and deactivate the first solid-state switch during the given positive half-cycle of the AC power, in response to determining that the voltage level across the storage capacitor has reached a maximum voltage level.

Another exemplary embodiment includes a power converter which comprises a control system that is configured to control a charging of a storage capacitor using current drawn from AC power applied to an input terminal of the power converter, to provide DC power to a load that is coupled to an output terminal of the power converter. The control system is configured to control the charging of the storage capacitor by: monitoring a voltage level across the storage capacitor; causing charging current to flow to the storage capacitor during a given positive half-cycle of the AC power to charge the storage capacitor to a maximum voltage level, in response to determining that the monitored voltage level across the storage capacitor is less than a minimum voltage level; and preventing charging current from flowing to the storage capacitor during the given positive half-cycle of the AC power, in response to determining that the monitored voltage level across the storage capacitor is less than the maximum voltage level and greater than the minimum voltage level.

Another exemplary embodiment includes a method which comprises converting AC power to DC power which is stored on a storage capacitor, wherein converting the AC power to DC power comprises: monitoring a voltage level across the storage capacitor; causing charging current to flow to the storage capacitor during a given positive half-cycle of the AC power to charge the storage capacitor to a maximum voltage level, in response to determining that the monitored voltage level across the storage capacitor is less than a minimum voltage level; and preventing charging current from flowing to the storage capacitor during the given positive half-cycle of the AC power, in response to determining that the monitored voltage level across the storage capacitor is less than the maximum voltage level and greater than the minimum voltage level.

Other embodiments will be described in the following detailed description of exemplary embodiments, which is to be read in conjunction with the accompanying figures.

### BRIEF DESCRIPTION OF THE DRAWINGS

FIG. 1 schematically illustrates a power converter according to an exemplary embodiment of the disclosure.

FIGS. 2A, 2B, 2C, and 2D are timing diagrams which depict simulated waveforms that illustrate exemplary modes of operation of a power converter according to an exemplary embodiment of the disclosure.

FIG. 3 illustrates a flow diagram of a method for converting AC power to DC power according to an exemplary embodiment of the disclosure.

FIG. 4 schematically illustrates a power converter according to another exemplary embodiment of the disclosure.

FIG. 5 schematically illustrates an intelligent electrical device which implements a power converter according to an exemplary embodiment of the disclosure.

### DETAILED DESCRIPTION

Embodiments of the disclosure will now be described in further detail with regard to power converters and techniques for converting AC power to DC power. In an exemplary embodiment, a power converter comprises a first solid-state switch, a storage capacitor, and a control system. The first solid-state switch is connected in an electrical path between a first node and a second node. The storage capacitor is coupled between the second node and a ground node. The control system configured to control charging of the storage capacitor. The control system is configured to: determine a voltage level across the storage capacitor; activate the first solid-state switch during a given positive half-cycle of AC power applied to the first node to allow current to flow from the first node to the second node to charge the storage capacitor, in response to determining that the voltage level across the storage capacitor is less than a minimum voltage level; and deactivate the first solid-state switch during the given positive half-cycle of the AC power, in response to determining that the voltage level across the storage capacitor has reached a maximum voltage level.

In another exemplary embodiment, which may be combined with one or more of the embodiments of the preceding paragraphs, the minimum voltage level and the maximum voltage level are programmable parameters of the control system.

In another exemplary embodiment, which may be combined with one or more of the embodiments of the preceding paragraphs, the storage capacitor is configured as a DC power source to supply DC power to a load that is coupled the second node of the power converter.

In another exemplary embodiment, which may be combined with one or more of the embodiments of the preceding paragraphs, the control system is configured to maintain the first solid-state switch deactivated during an entirety of each negative half-cycle of the AC power.

In another exemplary embodiment, which may be combined with one or more of the embodiments of the preceding paragraphs, the first solid-state switch comprises a high voltage MOSFET.

In another exemplary embodiment, which may be combined with one or more of the embodiments of the preceding paragraphs, the control system comprises a driver circuit that is configured to generate a regulated control voltage using current drawn from the AC power during negative half-cycles of the AC power, and utilize the regulated control voltage to drive the first solid-state switch during positive half-cycles of the AC power.

In another exemplary embodiment, which may be combined with one or more of the embodiments of the preceding paragraphs, the control system comprises a voltage sensing circuit, a first comparator, and a second comparator. The voltage sensing circuit is configured to generate a sense voltage that is proportional to a voltage level across the storage capacitor. The first comparator is configured to compare the sense voltage and a first threshold voltage, and generate a first output signal based on the comparison of the sense voltage and the first threshold voltage. The second comparator is configured to compare the sense voltage and a second threshold voltage, and generate a second output signal based on the comparison of the sense voltage and the second threshold voltage. The control system is configured to cause the first solid-state switch to be activated during a given positive half-cycle of the AC power, in response to determining that the sense voltage is less than both the first threshold voltage and the second threshold voltage, based on the first output signal and the second output signal of the first comparator and the second comparator.

In another exemplary embodiment, which may be combined with one or more of the embodiments of the preceding paragraphs, the control system further comprises a second solid-state switch and a latch circuit. The second solid-state switch is coupled a control terminal of the first solid-state switch. The latch circuit comprises a first input port, a second input port, and an output port. The first input port is coupled to an output port of the first comparator and configured to receive the first output signal. The second input port is coupled to an output port of the second comparator and configured to receive the second output signal. The output port is coupled to a control terminal of the second solid-state switch. The latch circuit is configured to output a control signal to control an activation and deactivation of the second solid-state switch, based on a logic level of the first output signal from the first comparator, and a logic level of the second output signal from the second comparator. The activation of the second solid-state switch causes the first solid-state switch to be deactivated, and the deactivation of the second solid-state switch allows the first solid-state switch to be activated during a positive half-cycle of the AC power.

In another exemplary embodiment, which may be combined with one or more of the embodiments of the preceding paragraphs, the latch circuit comprises a Set-Reset latch circuit.

In another exemplary embodiment, which may be combined with one or more of the embodiments of the preceding paragraphs, at least one of the first threshold voltage and the second threshold voltage is programmable.

In another exemplary embodiment, which may be combined with one or more of the embodiments of the preceding paragraphs, the voltage sensing circuit comprises a voltage divider circuit coupled in parallel to the storage capacitor. The voltage divider circuit comprises a sense node that is coupled to an input terminal of the first comparator and to an input terminal of the second comparator. The voltage divider circuit generates the sense voltage on the sense node.

In another exemplary embodiment, which may be combined with one or more of the embodiments of the preceding paragraphs, the voltage divider circuit comprises a programmable voltage division ratio.

Another exemplary embodiment includes an intelligent electrical device which comprises a power converter according to one or more of the embodiments of the preceding paragraphs, wherein the storage capacitor is configured as a DC power source to supply DC power to control circuitry of the intelligent electrical device. The intelligent electrical device can be, for example, an intelligent solid-state circuit breaker device, or an intelligent solid-state light switch device.

Another exemplary embodiment includes a power converter which comprises a control system configured to control a charging of a storage capacitor using current drawn from AC power applied to an input terminal of the power converter, to provide DC power to a load that is coupled to an output terminal of the power converter. The control system is configured to control the charging of the storage capacitor by: monitoring a voltage level across the storage capacitor; causing charging current to flow to the storage capacitor during a given positive half-cycle of the AC power to charge the storage capacitor to a maximum voltage level, in response to determining that the monitored voltage level across the storage capacitor is less than a minimum voltage level; and preventing charging current from flowing to the storage capacitor during the given positive half-cycle of the AC power, in response to determining that the monitored voltage level across the storage capacitor is less than the maximum voltage level and greater than the minimum voltage level.

In another exemplary embodiment, which may be combined with one or more of the embodiments of the preceding paragraphs, the control system is further configured to control the charging of the storage capacitor by preventing charging current to flow to the storage capacitor during negative half-cycles of the AC power, irrespective of the monitored voltage level across the storage capacitor.

In another exemplary embodiment, which may be combined with one or more of the embodiments of the preceding paragraphs, the DC power is utilized to power control circuitry of an intelligent electrical device.

Another exemplary embodiment includes a method which comprises converting AC power to DC power which is stored on a storage capacitor, wherein converting the AC power to DC power comprises: monitoring a voltage level across the storage capacitor; causing charging current to flow to the storage capacitor during a given positive half-cycle of the AC power to charge the storage capacitor to a maximum voltage level, in response to determining that the monitored voltage level across the storage capacitor is less than a minimum voltage level; and preventing charging current to flow to the storage capacitor during the given positive half-cycle of the AC power, in response to determining that the monitored voltage level across the storage capacitor is less than the maximum voltage level and greater than the minimum voltage level.

In another exemplary embodiment, which may be combined with one or more of the embodiments of the preceding paragraphs, the method further comprises preventing charging current to flow to the storage capacitor during negative half-cycles of the AC power, irrespective of the monitored voltage level across the storage capacitor.

It is to be understood that the various features shown in the accompanying drawings are schematic illustrations that are not drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the term “exemplary” as used herein means “serving as an example, instance, or illustration.” Any embodiment or design described herein as “exemplary” is not to be construed as preferred or advantageous over other embodiments or designs.

Further, it is to be understood that the phrase “configured to” as used in conjunction with a circuit, structure, element, component, or the like, performing one or more functions or otherwise providing some functionality, is intended to encompass embodiments wherein the circuit, structure, element, component, or the like, is implemented in hardware, software, and/or combinations thereof, and in implementations that comprise hardware, wherein the hardware may comprise discrete circuit elements (e.g., transistors, inverters, etc.), programmable elements (e.g., application specific integrated circuit (ASIC) devices, field programmable gate array (FPGA) devices, etc.), processing devices (e.g., central processing unit (CPU) devices, graphical processing unit (GPU) devices, microcontroller devices, etc.), one or more integrated circuits, and/or combinations thereof. Thus, by way of example only, when a circuit, structure, element, component, etc., is defined to be configured to provide a specific functionality, it is intended to cover, but not be limited to, embodiments where the circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as to cover embodiments when the circuit, structure, element, component, etc., is in a non-operational state (e.g., not connected nor otherwise deployed in a system, not powered on, not receiving an input, and/or not producing an output) or in a partial operational state.

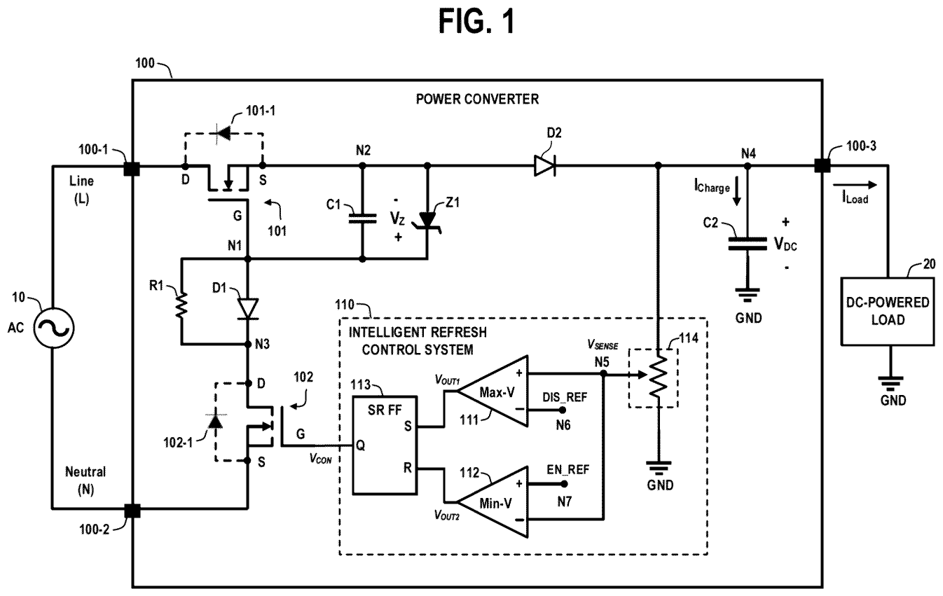

FIG. 1 schematically illustrates a power converter 100 according to an exemplary embodiment of the disclosure. In particular, FIG. 1 schematically illustrates a power converter 100 which comprises a first terminal 100-1 (or first power input terminal), a second terminal 100-2 (or second power input terminal), and a third terminal 100-3 (or DC power output terminal). The first terminal 100-1 and the second terminal 100-2 are configured to receive AC power that is supplied from an AC power source 10. The power converter 100 is configured to convert the input AC power to DC power that is applied to a DC-powered load circuit 20 (or load circuit 20). In particular, the power converter 100 is configured to convert the input AC power to a regulated DC voltage V_{DC} which is output on the third terminal 100-3 (DC power output terminal).

In some embodiments, the AC power source 10 comprises a utility power supply (e.g., AC mains) which provides an AC voltage waveform with a frequency of 60 Hz and a voltage of 120V RMS (a peak voltage of about 170V). For example, as schematically shown in FIG. 1, in some embodiments, the first terminal 100-1 is coupled to a line hot phase (L) of the AC power source 10, and the second terminal 100-2 is coupled to a neutral phase (N) of the AC power source 10. In other embodiments, the AC power source 10 can be other sources of AC power at different voltage levels and/or frequencies. The load circuit 20 comprises any type of circuit architecture which utilizes DC power that is generated by the power converter 100 to operate DC-powered circuits and components. For example, in some embodiments, the load circuit 20 comprises control circuitry of an intelligent electrical device such as an intelligent solid-state circuit breaker, an intelligent light switch device, an intelligent outlet device, an intelligent circuit interrupter device, etc.

The power converter 100 comprises a first solid-state switch 101, a second solid-state switch 102, a first diode D1, a second diode D2, a resistor R1, a first capacitor C1, a second capacitor C2 (alternatively, storage capacitor), a Zener diode Z1, and an intelligent refresh control system 110. The intelligent refresh control system 110 comprises a first comparator 111, a second comparator 112, a latch circuit 113, and a voltage sensing circuit 114. In some embodiments, the voltage sensing circuit 114 comprises a fixed voltage divider circuit with a fixed voltage division ratio. In other embodiments, as schematically illustrated in FIG. 1, the voltage sensing circuit 114 comprises a programmable voltage divider circuit (electronic/digital potentiometer) having a user-programmable voltage division ratio. The voltage sensing circuit 114 is configured to output a sense voltage V_{SENSE} on node N5, which is proportional to the magnitude of a DC voltage V_{DC} on node N4 (based on the voltage division ratio). Collectively, the second solid-state switch 102, the first and second diodes D1 and D2, the Zener diode Z1, the resistor R1, the first capacitor C1, and the intelligent refresh control system 110 collectively comprise a control system (or control circuitry), which is configured to control the operation of the first solid-state switch 101 and thereby control a flow of current (denoted I_{Charge}) which charges the storage capacitor C2 to generate the DC voltage V_{DC} on an output node (node N4) of the power converter 100, the details of which will be explained in further detail below.

In some embodiments, the first and second solid-state switches 101 and 102 each comprise a metal-oxide-semiconductor field-effect transistor (MOSFET) device. In some embodiments, the first and second solid-state switches 101 and 102 are N-type MOSFET devices and, in particular, high-voltage N-type MOSFET devices. The first and second solid-state switches 101 and 102 each comprise a source terminal(S), a drain terminal (D), a gate terminal (G), and a body terminal, wherein the source terminal(S) and the body terminal are commonly coupled. The first solid-state switch 101 includes an intrinsic body diode 101-1 which represents a P-N junction between a P-type substrate body to an N-doped drain region of an N-type MOSFET device. Similarly, the second solid-state switch 102 includes an intrinsic body diode 102-1 which represents a P-N junction between a P-type substrate body to an N-doped drain region of an N-type MOSFET device. By connecting (shorting) the body terminal (e.g., P-type substrate) to the source terminal(S), the intrinsic body diodes 101-1 and 102-1 are maintained in a revised-biased state when the first and second solid-state switches 101 and 102 are activated (e.g., turned on, in a “ON” state or activated state). In addition, an intrinsic substrate body-to-source diode is not shown as it is shorted out by the common connection between the source terminal(S) and the body terminal (or in other embodiments, the N+ source region and P-doped substrate body junction are shorted through source metallization).

As schematically illustrated in FIG. 1, the first capacitor C1 and the Zener diode Z1 are coupled in parallel between nodes N1 and N2. The first diode D1 and the resistor R1 are coupled in parallel between nodes N1 and N3. The second diode D2 is coupled to and between the nodes N2 and N4. Furthermore, the gate terminal (G) and source terminal(S) of the first solid-state switch 101 are coupled to nodes N1 and N2, respectively, while the drain terminal (D) of the first solid-state switch 101 is coupled to the first terminal 100-1. As explained in detail below, the first capacitor C1 and the Zener diode Z1 collectively implement a self-biasing driver circuit that is configured to generate a regulated voltage (e.g., regulated gate voltage VG) on the node N1 using current drawn from the AC power source 10, wherein the regulated voltage on the node N1 comprises a gate voltage that is utilized to drive the first solid-state switch 101. More specifically, the first capacitor C1 and the Zener diode Z1 collectively implement a self-biasing driver circuit that is configured to generate a regulated gate-to-source volage Vos across the nodes N1 and N2 to drive the first solid-state switch 101 into an activate state.

Furthermore, the gate terminal (G) of the second solid-state switch 102 is coupled to an output of the intelligent refresh control system 110, the drain terminal (D) of the second solid-state switch 102 is coupled to the node N3, and the source terminal(S) of the second solid-state switch 102 is coupled to the second terminal 100-2. The intelligent refresh control system 110 is configured to generate a control signal which is applied to the gate terminal (G) of the second solid-state switch 102 to control the activation (turn on) and deactivation (turn off) of the second solid-state switch 102. When the second solid-state switch 102 is deactivated, the first solid-state switch 101 will be activated to allow charging current (I_{Charge}) to flow and charge the second capacitor C2 during a positive half-cycle of an AC power of the AC power source 10. On the other hand, when the second solid-state switch 102 is activated, the first solid-state switch 101 will be deactivated. As explained in further detail below, the intelligent refresh control system 110 comprises logic to implement a refresh control protocol to control the operation of the first and second solid-state switches 101 and 102 to charge the storage capacitor C2 in an efficient manner over different load conditions.

In some embodiments, the first comparator 111 and the second comparator 112 each comprise an operational amplifier that is configured to operate as a voltage comparator. In some embodiments, the latch circuit 113 comprises a Set-Reset (SR) latch circuit comprising a first input port (set S input port), a second input port (reset R input port), and an output port (Q output port). The Q output port is coupled to the gate terminal (G) of the second solid-state switch 102. The first comparator 111 comprises (i) a non-inverting (+) input terminal which is coupled to a sense node (denoted N5), (ii) an inverting (−) input terminal which is coupled to a first threshold voltage node (denoted N6), and (iii) an output terminal which is coupled to the set S input port of the latch circuit 113. The second comparator 112 comprises (i) a non-inverting (+) input terminal which is coupled to a second threshold voltage node (denoted N7), (ii) an inverting (−) input terminal which is coupled to the sense node N5, and (iii) an output terminal which is coupled to the reset R input port of the latch circuit 113.

The voltage sensing circuit 114 comprises a voltage divider circuit that is configured to generate a sense voltage (denoted V_{SENSE}) on the sense node N5. As noted above, the sense voltage V_{SENSE} is a voltage that is proportional to a DC voltage V_{DC} across the storage capacitor C2 at the output node N4 of the power converter 100 based on a voltage division ratio of the voltage divider circuit of the voltage sensing circuit 114. In some embodiments, as noted above, the voltage sensing circuit 114 comprises a programmable voltage divider circuit which allows the voltage division ratio to be adjusted which, in turn, allows for the adjustment of correspondence between the sense voltage V_{SENSE} and the maximum output voltage V_{DC} of the power converter 100, as desired, for a given application. In other embodiments, the voltage sensing circuit 114 comprises a fixed voltage divider circuit which provides a fixed voltage division ratio.

As schematically illustrated in FIG. 1, a first threshold voltage (denoted DIS_REF) is applied to the threshold voltage node N6 at the inverting (−) input terminal of the first comparator 111. The first comparator 111 is configured to compare the sense voltage V_{SENSE} (on node N5) and the first threshold voltage DIS_REF (on node N6) and generate an output voltage V_{OUT1} based on the voltage comparison. More specifically, in the exemplary embodiment of FIG. 1, the first comparator 111 comprises a non-inverting comparator topology, wherein the first comparator 111 outputs a control voltage V_{OUT1} at a logic “1” voltage level, when the sense voltage V_{SENSE} is greater than the first threshold voltage DIS_REF (i.e., V_{OUT1}=logic “1” when V_{SENSE}>DIS_REF). On the other hand, the first comparator 111 outputs a control voltage V_{OUT1} at a logic “0” voltage level when the sense voltage V_{SENSE} is less than the first threshold voltage DIS_REF (i.e., V_{OUT1}=logic “0” when V_{SENSE}<DIS_REF).

Further, a second threshold voltage (denoted EN_REF) is applied to the threshold voltage node N7 at the non-inverting (+) input terminal of the second comparator 112. The second comparator 112 is configured to compare the sense voltage V_{SENSE} (on node N5) and the second threshold voltage EN_REF (on node N7) and generate an output voltage V_{OUT2} based on the voltage comparison. In the exemplary embodiment of FIG. 1, the second comparator 112 comprises an inverting comparator topology, wherein the second comparator 112 outputs a control voltage V_{OUT2} at a logic “1” voltage level, when the sense voltage V_{SENSE} is less than the second threshold voltage EN_REF (i.e., V_{OUT2}=logic “1” when V_{SENSE}<EN_REF). On the other hand, the second comparator 112 outputs a control voltage V_{OUT2} at a logic “0” voltage level when the sense voltage V_{SENSE} is greater than the second threshold voltage EN_REF (i.e., V_{OUT2}=logic “0” when V_{SENSE}>EN_REF).

The output V_{OUT1} of the first comparator 111 controls the set S input of the latch circuit 113, and the output V_{OUT2} of the second comparator 112 controls the reset R input of the latch circuit 113. The Q output of the latch circuit 113 comprises a control voltage V_{CON} which controls the operation of the second solid-state switch 102. The following truth table illustrates the operation of the latch circuit 113:

| | | Q | Q | |
|---|---|---|---|---|
| S | R | V_{CON} | V_{CON} | |
| V_{OUT1} | V_{OUT2} | (current) | (next) | STATE |
| 0 | 0 | 0 | 0 | NC |
| 0 | 0 | 1 | 1 | NC |
| 0 | 1 | 0 | 0 | RESET |
| 0 | 1 | 1 | 0 | RESET |
| 1 | 0 | 0 | 1 | SET |
| 1 | 0 | 1 | 1 | SET |

When the Q output (V_{CON}) of the latch circuit 113 is at a logic “0” level (“Reset” state), the second solid-state switch 102 is deactivated (turned off), which allows the first solid-state switch 101 to be activated (turned on). On the other hand, when the Q output (V_{CON}) of the latch circuit 113 is at a logic “1” level (“Set” state), the second solid-state switch 102 is activated, which causes the first solid-state switch 101 to be deactivated.

Depending on a desired maximum DC voltage (denoted V_{DC_MAX}) of the storage capacitor C2 (which is user programmable for a given application), the first comparator 111 is configured to “Set” the latch circuit 113 (i.e., the Q output is set to a logic “1” level), once the storage capacitor C2 has been charged to the maximum DC voltage V_{DC_MAX} which, as noted above, causes the second solid-state switch 102 to be activated which, in turn, causes first solid-state switch 101 to be deactivated. As the voltage V_{DC} on the storage capacitor C2 decreases (as result of the stored charge of the storage capacitor C2 being discharged by flow of load current I_{LOAD} to the DC-powered load circuit 20 over time), a refresh cycle will be initiated by the intelligent refresh control system 110 when the voltage V_{DC} on the storage capacitor C2 has decreased to a minimum DC voltage (denoted V_{DC_MIN}) which is user programmable for a given application. In particular, when the voltage V_{DC} on the storage capacitor C2 has decreased to V_{DC_MIN}, the second comparator 112 will “Reset” the latch circuit 113 (i.e., the Q output is set to a logic “0” level) which, as noted above, causes the second solid-state switch 102 to be deactivated which, in turn, allows the first solid-state switch 101 to be activated via the self-generated VGs voltage, to thereby recharge the storage capacitor C2 during a positive half-cycle of the input AC power.

It is to be noted that during heavy load conditions where the voltage on the storage capacitor C2 discharges relatively fast, a refresh operation can be triggered by the intelligent refresh control system 110 to recharge the storage capacitor C2 can occur during every positive half-cycle of the input AC power. On the other hand, during light load conditions where the voltage on the storage capacitor C2 discharges relatively slow, the refresh operation may not be triggered by the intelligent refresh control system 110 over two or more AC power cycles, until the voltage V_{DC} on the storage capacitor C2 has been determined (by the intelligent refresh control system 110) to have decreased to V_{DC_MIN}. Consequently, the controlled refresh methodology that is implemented by the intelligent refresh control system 110 serves to enhance the overall efficiency of the power converter 100 over various load conditions.

More specifically, the power converter 100 is configured to charge the storage capacitor C2 during a given positive half-cycle of the AC power applied to the first and second terminals 100-1 and 100-2 from the AC power source 10, when the voltage V_{DC} on the storage capacitor C2 has decreased to (or below) the minimum DC voltage V_{DC_MIN}. During the positive half-cycles of the input AC power, the second diode D2 is forward-biased, which allows charging current I_{Charge} to flow and charge the storage capacitor C2 when the first solid-state switch 101 is activated. On the other hand, during negative half-cycles of the input AC power, the second diode D2 is reverse-biased, which prevents the storage capacitor C2 from being discharged due to the negative phase of the input AC power applied to the first and second terminals 100-1 and 100-2. In particular, without the second diode D2, the storage capacitor C2 would start to discharge during a negative half-cycle of the input AC power as a result of current flow from the node N4 to the first terminal 100-1 through the forward-biased intrinsic body diode 101-1 of the first solid-state switch 101.

As noted above, the first capacitor C1 and the Zener diode Z1 are configured to implement a self-biasing driver circuit to generate a regulated voltage on the node N1 using current drawn from the AC power source 10, wherein the regulated voltage on the node N1 (e.g., Vos across nodes N1 and N2) s utilized to drive the first solid-state switch 101. In particular, during a negative half-cycle of the input AC power, current flows from the second terminal 100-2 to the first terminal 100-1 via an electrical path comprising the forward-biased intrinsic body diode 102-1 of the second solid-state switch 102, the resistor R1, the first capacitor C1, and the forward-biased intrinsic body diode 101-1 of the first solid-state switch 101. This current flow causes a voltage across the first capacitor C1 to increase until the capacitor voltage reaches a Zener voltage (denoted Vz) of the Zener diode Z1. The Zener voltage (e.g., Vz=10V or greater) provides a regulated gate-to-source voltage (VGs) across the nodes N1 and N2 to drive the first solid-state switch 101 during a next positive half-cycle of the input AC signal to thereby charge the storage capacitor C2 to the maximum DC voltage V_{DC_MAX}, as needed. In this exemplary configuration, the Zener diode Z1 serves to clamp Vos for driving the first solid-state switch 101 to the Zener voltage Vz of the Zener diode Z1.

At the beginning of a given positive half-cycle of the input AC power (or at some time during the positive half-cycle), if the voltage V_{DC} on the storage capacitor C2 is less than the minimum DC voltage V_{DC_MIN}, the first solid-state switch 101 will be placed into an activated state to allow charging current I_{Charge} to flow and charge the storage capacitor C2 to the maximum DC voltage V_{DC_MAX}. In particular, when the voltage V_{DC} on the storage capacitor C2 is less than the minimum DC voltage V_{DC_MIN}, the sense voltage V_{SENSE} at the node N5 will be less than both the first reference voltage DIS_REF (applied to the first comparator 111) and the second reference voltage EN_REF (applied to the second comparator 112), i.e., V_{SENSE}<DIS_REF and V_{SENSE}<EN_REF. In this instance, the output V_{OUT1} of the first comparator 111 will be at a logic “0” level (S=0), and the output V_{OUT2} of the second comparator 112 will be at logic “1” level (R=1), which causes the Q output (V_{CON}) of the latch circuit 113 to be in a reset state (Q=0). The reset state (Q=0) of the latch circuit 113 causes the second solid-state switch 102 to be deactivated, which allows the first solid-state switch 101 to be activated and driven by the regulated Vos voltage (e.g., Zener voltage Vz) across the nodes N1 and N2, in which case charging current I_{Charge} flows to charge the storage capacitor C2.

During the given positive half-cycle of the input AC power, as the voltage V_{DC} of the storage capacitor C2 increases to an intermediate level where V_{SENSE} is less than DIS_REF but greater than EN_REF, the output V_{OUT2} of the second comparator 112 will transition to a logic “0” level (R=0), while the output V_{OUT1} of the first comparator 111 will remain at the logic “0” level (S=0). In this instance, the Q output of the latch circuit 113 will not change (NC), and remain at logic “0” since the transition of V_{OUT2} (at the reset R input of the latch circuit 113) to logic “0” level does not cause a change in state of the latch circuit 113. As such, the second solid-state switch 102 remains in a deactivated state and the first solid-state switch 101 remains in an activated state to continue charging the storage capacitor C2 to the maximum V_{DC}.

At some point during the given positive half-cycle of the input AC power, when the voltage V_{DC} on the storage capacitor C2 reaches the maximum DC voltage V_{DC_MAX}, the first solid-state switch 101 will be placed into a deactivated state to interrupt and terminate the flow of charging current I_{Charge} to the storage capacitor C2. In particular, when the voltage V_{DC} on the storage capacitor C2 reaches the maximum DC voltage V_{DC_MAX}, the sense voltage V_{SENSE} at the node N5 will be greater than both the first and second reference voltages DIS_REF but greater than EN_REF applied to the respective first and second comparators 111 and 112, i.e., V_{SENSE}>DIS_REF and V_{SENSE}>EN_REF. In this instance, the output V_{OUT1} of the first comparator 111 will transition to a logic “1” level (S=1), and the output V_{OUT2} of the second comparator 112 will remain at the logic “0” level (R=0), which causes the Q output (V_{CON}) of the latch circuit 113 to transition to a Set state (Q=1). The Set state (Q=1) of the latch circuit 113 causes the second solid-state switch 102 to be placed into an activated state which, in turn, causes the first solid-state switch 101 to be placed into a deactivated state.

In particular, when the second solid-state switch 102 is activated, the node N1 is essentially pulled down close to ground (neutral) potential. In this instance, the voltage on node N1 falls below the threshold voltage VT of the first solid-state switch 101 which causes the first solid-state switch 101 to be deactivated. In this instance, the deactivation of the first solid-state switch 101 terminates the flow of charging current I_{Charge} to the storage capacitor C2 which, in turn, prevents further charging of the storage capacitor C2 to a voltage greater than the maximum DC voltage V_{DC_MAX}.

When the storage capacitor C2 is charged to the maximum DC voltage V_{DC_MAX} and the charging current is terminated, the voltage V_{DC} on the storage capacitor C2 will begin to decrease as a result of the storage capacitor C2 being discharged due to the flow of load current I_{Load} when DC power is supplied to the load circuit 20 connected thereto. The rate at which storage capacitor C2 is discharged will vary depending on the load conditions. In this regard, when the storage capacitor C2 is charged to the maximum DC voltage V_{DC} MAX in a given positive half-cycle of the input AC power, under certain load conditions, the second capacitor C2 will discharge during the remainder of the given positive half-cycle and during the entirety of the subsequent negative half-cycle.

As the voltage V_{DC} of the storage capacitor C2 decreases to an intermediate level in which V_{SENSE} is less than DIS_REF but greater than EN_REF, the output V_{OUT1} of the first comparator 111 will transition to a logic “0” level (S=0) while the output V_{OUT2} of the second comparator 112 will remain at the logic “0” level (R=0). In this instance, the Q output (V_{CON}) of the latch circuit 113 will not change (NC), and remain at logic “1” since transition of V_{OUT1} to the logic “0” level (which is applied to the set S input of the latch circuit 113) does not cause a change in state of the latch circuit 113. When the voltage V_{DC} of the storage capacitor C2 decreases to the minimum DC voltage level V_{DC_MIN} (where V_{SENSE} is less than DIS_REF and less than EN_REF), the output V_{OUT2} of the second comparator 112 will transition to a logic “1” level (R=1) while the output V_{OUT1} of the first comparator 111 will remain at the logic “0” level (S=0). In this instance, the latch circuit 113 will be placed in a Reset state in which case the Q output (V_{CON}) of the latch circuit 113 transitions to a logic “0” level (Q=0). If the Q output of the latch circuit 113 transitions to a logic “0” level during a negative half-cycle of the input AC power, the first solid-state switch 101 will remain in a deactivated state (despite the second solid-state switch 102 being in a deactivated state) at least until the input AC power transitions to the next positive half-cycle, in which case the first solid-state switch 101 will be activated and allow charging current I_{Charge} to flow to charge the storage capacitor C2 during the positive half-cycle of the input AC power.

Next, as the voltage V_{DC} of the storage capacitor C2 increases to the maximum DC voltage level V_{DC_MAX} as a result of being charged during the positive half-cycle of the input AC power, the voltage V_{SENSE} on node N5 will be greater than the first and second threshold voltages DIS_REF and EN_REF of the first and second comparators 111 and 112, respectively. As a result, the output V_{OUT1} of the first comparator 111 will transition to a logic “1” level (S=1) and the output V_{OUT2} of the second comparator 112 will be at a logic “0” level (R=0), which causes the latch circuit 113 to be placed in a Set state where the Q output (V_{CON}) of the latch circuit 113 transitions to a logic “1” level (Q=1). As a result, the second solid-state switch 102 is activated, which causes the first solid-state switch 101 to be deactivated and terminates the flow of charging current I_{Charge} to the storage capacitor C2.

As described above, the power converter 100 implements an intelligent refreshing mechanism to charge the storage capacitor C2 in an efficient manner for different load conditions. The maximum and minimum DC voltage values (V_{DC_MAX} and V_{DC_MIN}) for disabling and enabling the charging of the storage capacitor C2, are user-programmable values which can be adjusted by, e.g., changing the first and second threshold voltages DIS_REF and EN_REF for a given sense voltage V_{SENSE} parameter (which is fixed or programmable, as noted above). The intelligent refresh control system 110 is configured to initiate a refresh cycle to cause the storage capacitor C2 to be recharged to V_{DC_MAX} during a positive half-cycle of the input AC power when the voltage V_{DC} across the storage capacitor C2 drops below V_{DC_MIN}. On the other hand, during a positive-half cycle of the input AC power, when the voltage V_{DC} on the storage capacitor C2 falls below V_{DC_MAX} but does not fall below V_{DC_MIN}, the intelligent refresh control system 110 will delay the initiation of a next refresh cycle and wait until the voltage V_{DC} on the storage capacitor C2 decreases to V_{DC_MIN}.

Moreover, as noted above, the storage capacitor C2 is not charged during negative half-cycles of the input AC power, and the diode D2 prevents current flow from node N4 to node N2 during negative half-cycles of the input AC power to thereby prevent discharging of the storage capacitor C2. Instead, during negative half-cycles of the input AC power, the node N1 is pre-charged to the regulated voltage (i.e., Zener voltage Vz of Z1) via current flow from the second terminal 100-2, through the intrinsic body diode 102-1 of the second solid-state switch 102, through the resistor R1 and to the clamping circuit comprising the capacitor C1 and the Zener diode Z1, as discussed above. In this manner, the first solid-state switch 101 can placed into an activated state by the regulated voltage Vos generated across nodes N1 and N2 to thereby allow the charging current I_{Charge} to flow and charge the storage capacitor C2 during a next positive half-cycle of the input AC power, if the intelligent refresh control system 110 deems it necessary (e.g., if the voltage V_{DC} across the storage capacitor C2 has reached V_{DC_MIN}. In this regard, as noted above, during heavy load conditions where the voltage V_{DC} on the storage capacitor C2 discharges relatively fast, the refresh operation can occur during every positive half-cycle of the input AC power. On the other hand, during light load conditions where the voltage V_{DC} on the storage capacitor C2 discharges relatively slow, the refresh operation may not occur for two or more AC power cycles. Consequently, the controlled refresh methodology enhances the overall efficiency of the power converter 100, irrespective of load conditions, such as shown in 2A-2D.

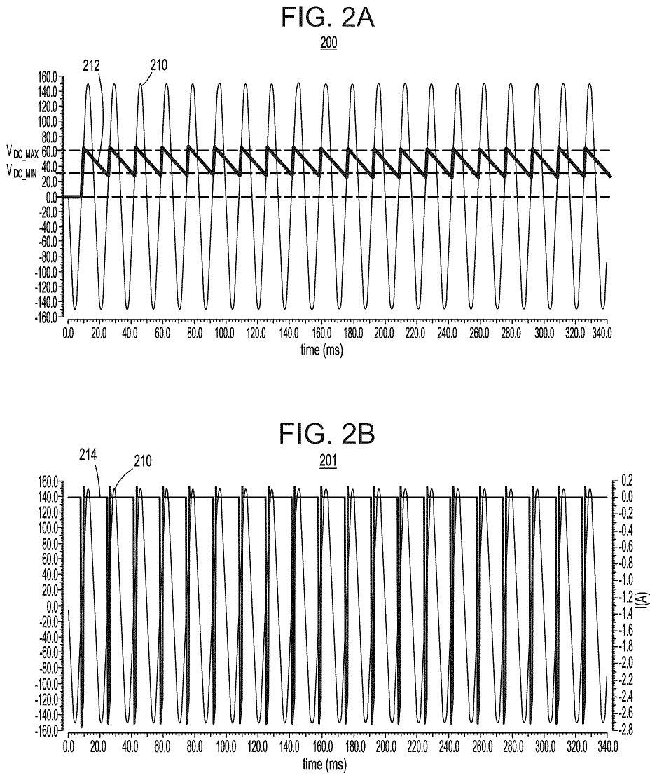

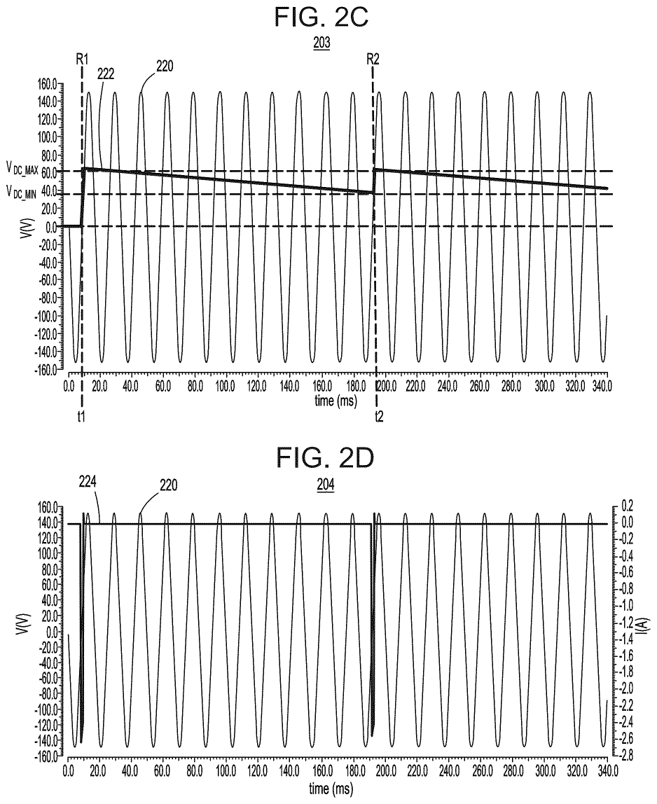

In particular, FIGS. 2A, 2B, 2C, and 2D are timing diagrams which depict simulated waveforms that illustrate exemplary modes of operation of a power converter, according to an exemplary embodiment of the disclosure. For purposes of illustration, FIGS. 2A, 2B, 2C, and 2D will be described in the context of exemplary modes of operation of the exemplary power converter 100 of FIG. 1. In particular, FIG. 2A depicts a timing diagram 200 which illustrates an exemplary AC voltage waveform 210 (e.g., input AC power) which is applied to the power converter 100, and an exemplary DC voltage waveform 212 (V_{DC}) which is generated by the power converter 100 under relatively high DC load conditions. FIG. 2B is a corresponding timing diagram 201 which illustrates the same exemplary AC voltage waveform 210 of FIG. 2A, as well as an exemplary current waveform 214 which represents a transient current (or capacitor refresh current) that is generated through the first solid-state switch 101 of FIG. 1.

As shown in FIG. 2A the exemplary DC voltage waveform 212 (V_{DC}) comprises a triangular-shaped voltage waveform which transitions between about 60V (e.g., V_{DC_MAX}) and about 30V (e.g., V_{DC_MIN}). FIGS. 2A and 2B illustrate an exemplary mode of operation of the power converter 100 under a heavy DC load condition in which a refresh operation is initiated at a beginning of each positive half-cycle of the AC voltage waveform 210. As shown by the current waveform 214 in FIG. 2B, a charging current is generated for a short duration at the beginning of each positive half-cycle of the AC voltage waveform 210 to recharge the storage capacitor C2 up to the maximum V_{DC} (e.g., V_{DC_MAX} of 60V).

Next, FIG. 2C depicts a timing diagram 203 which illustrates an exemplary AC voltage waveform 220 (e.g., input AC power) that is applied to the power converter 100, and an exemplary DC voltage waveform 222 (V_{DC}) which is generated by the power converter 100 under relatively low DC load conditions. FIG. 2D depicts a corresponding timing diagram 204 which illustrates the same exemplary AC voltage waveform 220 of FIG. 2C, as well as an exemplary current waveform 224 which represents a transient current (or capacitor refresh current) that is generated through the first solid-state switch 101 of FIG. 1, under the relatively low DC load conditions.

As shown in FIG. 2C, the exemplary DC voltage waveform 212 (V_{DC}) comprises a triangular-shaped voltage waveform which transitions between about 60V (e.g., V_{DC_MAX}) and about 30V (e.g., V_{DC_MIN}). FIGS. 2C and 2D illustrate an exemplary mode of operation of the power converter 100 under relatively light DC load conditions in which a refresh operation is initiated after multiple positive half-cycles of the AC voltage waveform 220. For example, FIGS. 2C and 2D illustrate an exemplary embodiment in which a first refresh operation R1 is initiated (at time t1) at a beginning of a positive half-cycle of the AC voltage waveform 220, which is followed by the initiation of a second refresh operation R2 (at time t2) at the beginning of a positive half-cycle of the AC voltage waveform 220, wherein the second refresh operation R2 is initiated at the beginning of the eleventh 11th positive half-cycle of the AC voltage waveform 220 following the first refresh operation R1. As shown in FIG. 2D, a charging current is generated for a short duration (as shown by the current spikes) in each positive half-cycle of the AC voltage waveform 220 in which the refresh operations R1 and R² are initiated to recharge the storage capacitor C2 up to the maximum V_{DC} (e.g., about 60V). In this exemplary embodiment, as noted above, the setting of the minimum DC voltage V_{DC_MIN} for triggering the refresh operation prevents a refresh operation from being initiated in every positive half-cycle of the AC voltage waveform 220 in instances where the regulated DC voltage V_{DC} across the storage capacitor C2 slightly decreases below the maximum DC voltage V_{DC_MAX} from one positive half-cycle to the next, under relatively light DC load conditions.

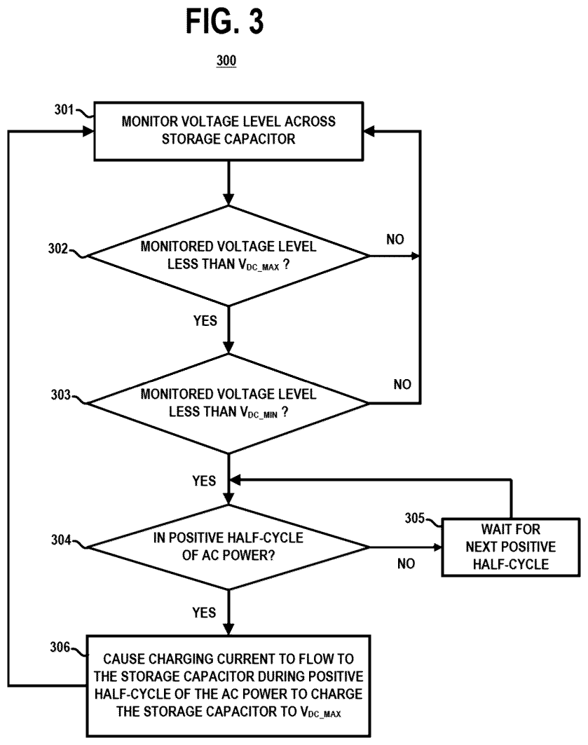

FIG. 3 illustrates a flow diagram of a method 300 for converting AC power to DC power, according to an exemplary embodiment of the disclosure. In some embodiments, FIG. 3 illustrates an exemplary mode of operation of the power converter 100 of FIG. 1 for converting AC power to DC power which is stored on the storage capacitor C2, according to an exemplary embodiment of the disclosure. The method 300 comprises monitoring a voltage level across the storage capacitor C2 (block 301). For example, in some embodiments, as discussed above, the intelligent refresh control system 110 implements the voltage sensing circuit 114 to continuously monitor the voltage V_{DC} across the storage capacitor C2 by generating and outputting a sense voltage V_{SENSE} which is proportional to the magnitude of the DC voltage V_{DC} across the storage capacitor C2 (based on given voltage division ratio).

When the power converter 100 determines that the voltage V_{DC} across the storage capacitor C2 is not less than the maximum DC voltage V_{DC_MAX} (negative determination in block 302), no refresh operation is initiated and the control system continues to monitor the voltage level across the storage capacitor C2 (block 301). When the power converter 100 determines that the voltage V_{DC} across the storage capacitor C2 is less than the maximum DC voltage V_{DC_MAX} (affirmative determination in block 302) but not less the minimum DC voltage V_{DC_MIN} (negative determination in block 303), no refresh operation is initiated and the control system continues to monitor the voltage level across the storage capacitor C2 (block 301).

On the other hand, when the power converter 100 determines that the voltage V_{DC} across the storage capacitor C2 is less than the maximum DC voltage V_{DC_MAX} (affirmative determination in block 302) and less than the minimum DC voltage V_{DC_MIN} (affirmative determination in block 303), but that the AC power is not in a positive half-cycle (negative determination in block 304), no refresh operation is initiated, and the control system will wait (block 305) until the next positive half-cycle of the AC power to initiate a refresh operation. Once the next positive-half-cycle of the AC power is reached (affirmative determination in block 304), the power converter 100 initiates a refresh operation to cause charging current to flow to the storage capacitor C2 during the positive half-cycle of the AC power to thereby charge the storage capacitor C2 to the maximum voltage level V_{DC_MAX} (block 306). Moreover, as noted above, the power converter 100 prevents charging current to flow to the storage capacitor C2 during negative half-cycles of the AC power, irrespective of the monitored voltage level across the storage capacitor C2.

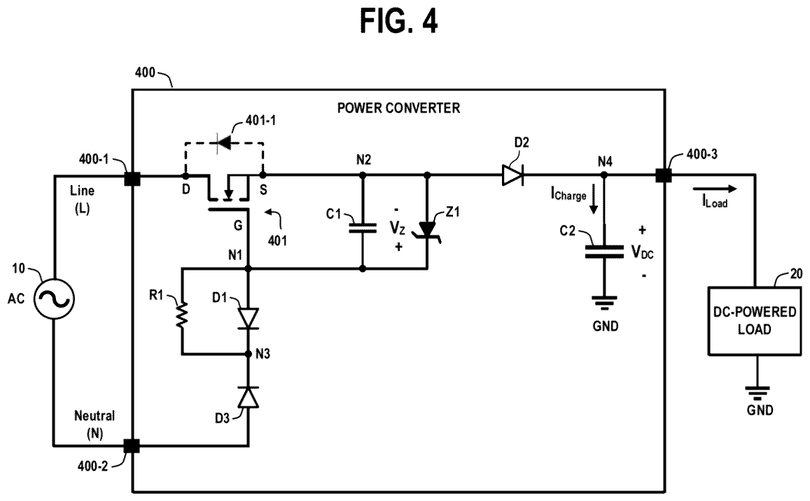

FIG. 4 schematically illustrates a power converter according to another exemplary embodiment of the disclosure. In particular, FIG. 4 schematically illustrates a power converter 400 which comprises a first terminal 400-1 (or first power input terminal), a second terminal 400-2 (or second power input terminal), and a third terminal 400-3 (or DC power output terminal). The first terminal 400-1 and the second terminal 400-2 are configured to receive AC power that is supplied from an AC power source 10. The power converter 400 is configured to convert the input AC power to DC power that is applied to a DC-powered load circuit 20 (or load circuit 20). In particular, the power converter 400 is configured to convert the input AC power to a regulated DC voltage V_{DC} which is output on the third terminal 400-3 (DC power output terminal).

In some embodiments, the AC power source 10 comprises a utility power supply (e.g., AC mains) which provides an AC voltage waveform with a frequency of 60 Hz and a voltage of 120V RMS (a peak voltage of about 170V). For example, as schematically shown in FIG. 4, in some embodiments, the first terminal 400-1 is coupled to a line hot phase (L) of the AC power source 10, and the second terminal 100-2 is coupled to a neutral phase (N) of the AC power source 10. In other embodiments, the AC power source 10 can be other sources of AC power at different voltage levels and/or frequencies. The load circuit 20 comprises any type of circuit architecture which utilizes DC power that is generated by the power converter 400 to operate DC-powered circuits and components. For example, in some embodiments, the load circuit 20 comprises control circuitry of an intelligent electrical device such as an intelligent solid-state circuit breaker, an intelligent light switch device, an intelligent outlet device, an intelligent circuit interrupter device, etc.

The power converter 400 comprises a solid-state switch 401, a first diode D1, a second diode D2, a third diode D3, a resistor R1, a first capacitor C1, a second capacitor C2 (alternatively, storage capacitor), and a Zener diode Z1. Collectively, the solid-state switch 401, the first, second, and third diodes D1, D2 and D3, the Zener diode Z1, the resistor R1, and the first capacitor C1 comprise a self-regulated power management circuit which is configured to control the flow of current (denoted I_{Charge}) which charges the storage capacitor C2 to generate the DC voltage V_{DC} on an output node (node N4) of the power converter 400.

In contrast to the exemplary power converter 100 of FIG. 1 which implements a feedback architecture (via the intelligent refresh control system 110 and the second solid-state switch 102) to control the activation and deactivation of the first solid-state switch 101 to thereby control the charging of the storage capacitor C2, the activation and deactivation of the solid-state switch 401 of the power converter 400 is not controlled by feedback. Instead, the self-biasing driver circuit, which is implemented by the first capacitor C1 and the Zener diode Z1, is configured to (i) generate a regulated gate-to-source voltage Vos across nodes N1 and N2 using current drawn from the AC power source 10 during each negative half-cycle of the input AC power, to drive the solid-state switch 401 at the beginning of each positive half-cycle of the input AC power, and (ii) cause the regulated Vos to be dissipated at some point during a beginning portion of each positive half-cycle of the input AC power so that the solid-state switch 401 is deactivated before the input AC power reaches a peak level (e.g., before an input AC voltage waveform of the AC power reached a peak voltage of 170 V). In this instance, the storage capacitor C2 is charged up to a V_{DC} voltage level (e.g., 70 V) which is less than the peak voltage (e.g., 170 V) of the input AC power.

More specifically, during a given negative half-cycle of the input AC power, current flows from the second terminal 400-2 to the first terminal 400-1 via an electrical path comprising the third diode D3 (which is forward-biased), the resistor R1, the first capacitor C1, and the forward-biased intrinsic body diode 401-1 of the solid-state switch 401. This current flow causes a voltage across the first capacitor C1 to increase until the capacitor voltage reaches a Zener voltage Vz of the Zener diode Z1. The Zener voltage Vz provides a regulated Vos across nodes N1 and N2 to drive the solid-state switch 401 during a next positive half-cycle of the input AC signal to thereby charge the storage capacitor C2. In this exemplary configuration, the Zener diode Z1 serves to clamp the magnitude of Vos for driving the solid-state switch 401 to the Zener voltage Vz of the Zener diode Z1.

At the beginning of a given positive half-cycle of the input AC power, the solid-state switch 401 is in an activated state and driven by the regulated Vos across nodes N1 and N2. In this instance, a charging current I_{Charge} will flow from the first terminal 400-1 through the solid-state switch 401 and the second diode D2 (which is forward biased) to charge the storage capacitor C2 to a given DC level V_{DC}. Following the transition into the given positive half-cycle of the input AC power, the first capacitor C1 will start and continue to discharge during the beginning portion of the given positive half-cycle until the magnitude of Vos across nodes N1 and N2 falls below the threshold voltage of the solid-state switch 401, which causes the solid-state switch 401 to be turned off (deactivated). The deactivation of the solid-state switch 401 terminates the flow of the charging current I_{Charge} to the storage capacitor C2, thereby terminating the charging process.

In this exemplary configuration, the solid-state switch 401 will remain activated for a period of time during a beginning portion of each positive-half cycle of the input AC power (while the voltage Vos across nodes N1 and N2 remains above the threshold voltage of the solid-state switch 401), to allow the storage capacitor C2 to be charged during the beginning portion of each positive half-cycle of the input AC power. In the exemplary configuration of the power converter 400 of FIG. 4, the first capacitor C1 is designed to have a relatively small capacitance so that the first capacitor C1 discharges relatively fast during the beginning portion of the positive half-cycle of the AC input power, and thereby cause the voltage Vos across nodes N1 and N2 to rapidly decrease to a level which causes the solid-state switch 401 to turn off and terminate the flow of charging current I_{Charge} to the storage capacitor C2.

More specifically, in an exemplary embodiment, the first capacitor C1 is designed to have a relatively small capacitance which, in turn, results in a relatively high discharge rate of the first capacitor C1, so that the solid-state switch 401 is turned off at some point during a beginning portion of each positive-half cycle of the AC power, e.g., before reaching a peak voltage. In this exemplary configuration, the capacitance of the first capacitor C1 can be selected to achieve a given discharge rate so that the voltage Vos is decreased to a level below the threshold voltage of the solid-state switch 401 at a period of time following the transition to the positive half-cycle of the input AC power when the input voltage of the input AC power reaches a target voltage level, e.g., 40V, 50V, 60V, 70V, etc., before reaching a peak voltage level (e.g., 170V), to thereby limit the maximum voltage V_{DC} at which the storage capacitor C2 is charged.

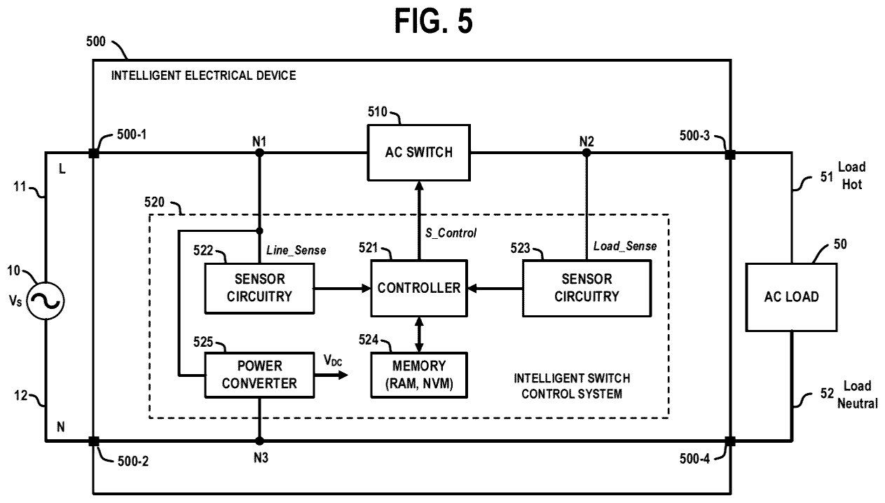

It is to be understood that the exemplary power converters 100 and 400 of FIGS. 1 and 4 can be implemented in various applications. For example, the power converters 100 and 400 can be used to generate DC power to control circuitry of an intelligent electrical device, such as an intelligent solid-state circuit breaker, an intelligent solid-state light switch device (e.g., intelligent dimmer switch), an intelligent circuit interrupter device, etc. For example, FIG. 5 schematically illustrates an intelligent electrical device 500 which implements a power converter, according to an exemplary embodiment of the disclosure. The intelligent electrical device 500 is configured to control AC power that is supplied from an AC power source 10 (e.g., AC mains) to an AC load 50. The intelligent electrical device 500 can be any type of intelligent electrical device which is configured to switchably connect/disconnect AC power to/from a given load.

As schematically shown in FIG. 5, in some embodiments, the intelligent electrical device 500 comprises a first power input terminal 500-1, a second power input terminal 500-2, a first load terminal 500-3, a second load terminal 500-4, an AC switch 510, and an intelligent switch control system 520. The intelligent switch control system 520 comprises various components and circuitry such as a controller 521, sensor circuitry 522 and 523, one or more memory devices 524, and a power converter 525. The power converter 525 can be implemented using any one of the exemplary power converters 100 or 400 as discussed above to generate a DC voltage V_{DC} which is utilized to provide a DC supply voltage for operating the various components 521, 522, 523, and 524 of the intelligent switch control system 520. In some embodiments, the power converter 525 further comprises DC-to-DC converter circuit which is configured to convert the DC voltage V_{DC} generated by the power converter 100 or 400 to one or more DC operating voltage levels as needed to operate the various components 521, 522, 523, and 524 of the intelligent switch control system 520. Depending on the type of device and given application (e.g., intelligent circuit breaker, intelligent electrical switch, etc.), the intelligent electrical device 500 and intelligent switch control system 520 may comprise other types of mechanical and/or electrical components to perform specific functions that are associated with a given application. The intelligent switch control system 520 may comprise a system-on-a-chip (SoC) device or a system-in-package (SIP) device which integrates the various components 521, 522, 523, 524, and 525 or portions thereof in a package structure.

In the exemplary embodiment of FIG. 5, the first and second power input terminals 500-1 and 500-2 are coupled, respectively, to a line (L) phase 11 and a neutral (N) phase 12 of the AC power source 10. The first and second load terminals 500-3 and 500-4 are configured to connect the intelligent electrical device 500 to a load hot line 51 and a load neutral line 52, respectively, which are connected to the AC load 50. In some embodiments, the intelligent electrical device 500 comprises only three terminals 500-1, 500-2, and 500-3, in which case the load neutral line 52 of the AC load 50 is connected directly to the neutral (N) phase 12 of the AC power source 10 (e.g., connected to a neutral bar in an electrical distribution panel, or connected to a neutral wire of a branch circuit, etc.).

Moreover, as schematically illustrated in FIG. 5, the AC switch 510 is connected between a first node N1 (alternatively, line hot node or line sense node) and a second node N2 (alternatively, load hot node or load sense node) in an electrical path between the first power input terminal 500-1 and the first load terminal 500-3. In some embodiments, the AC switch 510 comprises a bidirectional solid-state switch device which comprises two serially connected solid-state switches in a common source or common drain configuration. The AC switch 510 is controlled by a switch control signal (denoted S_Control) which is generated by the controller 521, wherein the switch control signal S_Control causes the AC switch 510 to be placed in one of (i) an activated state (turned on) to connect AC power to the AC load 50 and (ii) a deactivated state (turned off) to disconnect AC power from the AC load 50.

In some embodiments, the controller 521 is implemented using at least one intelligent, programmable hardware processing device such as a microprocessor, a microcontroller, an ASIC, an FPGA, a CPU, etc., which is configured to execute software routines to intelligently control the operation of the AC switch 510 to perform various functions, depending on the device type of the intelligent electrical device 500. In some embodiments, the one or more memory devices 524 comprise volatile random-access memory (RAM) and non-volatile memory (NVM), such as Flash memory, to store calibration data, operational data, and executable code for performing various intelligent operations of the intelligent electrical device 500, depending on the device type (e.g., intelligent circuit break, intelligent dimmer switch, etc.) For example, in some embodiments where the intelligent electrical device 500 comprises an intelligent electrical light switch with dimming capability, the controller 521 may execute a PWM (pulse width modulation) process to generate a pulse width modulated switch control signal S_Control to modulate the turn-on time of the AC switch 510 during positive and negative half cycles of the input AC power to thereby modulate the amount of AC power supplied to the AC load 50.

The sensor circuitry 522 comprises voltage detection and/or current detection circuitry to sense a line voltage and/or a line current at node N1 (line side of the AC switch 510). In some embodiments, the sensor circuitry 522 comprises voltage detection circuitry and/or current detection circuitry to sense load voltage and/or load current at node N2. The configuration and types of sensors used for the sensor circuitry 522 and 523 will vary depending on the application. For example, for light dimming applications, the sensor circuitry 522 may comprises a voltage phase detector to determine zero-crossings of the AC supply voltage waveform at node N1 and the direction of polarity transition of the AC supply voltage waveform at node N1 (e.g., transition from a positive to a negative half-cycle, or transition from a negative to a positive half-cycle of AC supply voltage waveform). The zero-crossing detections are processed by the controller 521 to determine and control the timing at which the AC switch 510 is activated and deactivated following a detected zero-voltage crossing of the AC supply voltage waveform at the line sense node N1.

In some embodiments, for intelligent circuit breaker applications, the sensor circuitry 523 comprises current detection circuitry to sense a magnitude of load current at node N2. In this regard, the sensor circuitry 523 can be utilized by the controller 521 to detect fault conditions, e.g., overcurrent, short circuit, etc., and allow the controller 521 to deactivate the AC switch 510 in the event that a fault condition is detected. In some embodiments, the intelligent electrical device 500 comprises an intelligent solid-state circuit breaker which is implemented using exemplary circuit breaker architectures and techniques as disclosed in U.S. Pat. No. 11,373,831, which is commonly assigned and fully incorporated herein by reference.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, and to enable others of ordinary skill in the art to understand the embodiments disclosed herein.

What is claimed is:

1. A power converter, comprising:
a first solid-state switch connected in an electrical path between a first node and a second node;
a storage capacitor coupled between the second node and a ground node; and
a control system configured to control a charging of the storage capacitor, wherein the control system is configured to:
determine a voltage level across the storage capacitor;
activate the first solid-state switch during a given positive half-cycle of alternative current (AC) power applied to the first node to allow current to flow from the first node to the second node to charge the storage capacitor, in response to determining that the voltage level across the storage capacitor is less than a minimum voltage level; and
deactivate the first solid-state switch during the given positive half-cycle of the AC power, in response to determining that the voltage level across the storage capacitor has reached a maximum voltage level.

2. The power converter of claim 1, wherein the minimum voltage level and the maximum voltage level are programmable parameters of the control system.

3. The power converter of claim 1, wherein the storage capacitor is configured as a direct current (DC) power source to supply DC power to a load that is coupled the second node of the power converter.

4. The power converter of claim 1, wherein the control system is configured to maintain the first solid-state switch deactivated during an entirety of each negative half-cycle of the AC power.

5. The power converter of claim 1, wherein the first solid-state switch comprises a high voltage MOSFET.

6. The power converter of claim 1, wherein the control system comprises a driver circuit that is configured to generate a regulated control voltage using current drawn from the AC power during negative half-cycles of the AC power, and utilize the regulated control voltage to drive the first solid-state switch during positive half-cycles of the AC power.

7. The power converter of claim 1, wherein the control system comprises:
a voltage sensing circuit configured to generate a sense voltage that is proportional to a voltage level across the storage capacitor;
a first comparator configured to compare the sense voltage and a first threshold voltage, and generate a first output signal based on the comparison of the sense voltage and the first threshold voltage; and
a second comparator configured to compare the sense voltage and a second threshold voltage, and generate a second output signal based on the comparison of the sense voltage and the second threshold voltage;
wherein the control system is configured to cause the first solid-state switch to be activated during a given positive half-cycle of the AC power, in response to determining that the sense voltage is less than both the first threshold voltage and the second threshold voltage, based on the first output signal and the second output signal of the first comparator and the second comparator.

8. The power converter of claim 7, wherein the control system further comprises:
a second solid-state switch coupled a control terminal of the first solid-state switch; and
a latch circuit comprising:
a first input port coupled to an output port of the first comparator and configured to receive the first output signal;
a second input port coupled to an output port of the second comparator and configured to receive the second output signal; and
an output port coupled to a control terminal of the second solid-state switch;
wherein the latch circuit is configured to output a control signal to control an activation and deactivation of the second solid-state switch, based on a logic level of the first output signal from the first comparator, and a logic level of the second output signal from the second comparator;
wherein activation of the second solid-state switch causes the first solid-state switch to be deactivated; and
wherein deactivation of the second solid-state switch allows the first solid-state switch to be activated during a positive half-cycle of the AC power.

9. The power converter of claim 8, wherein the latch circuit comprises a Set-Reset latch circuit.

10. The power converter of claim 7, wherein at least one of the first threshold voltage and the second threshold voltage is programmable.

11. The power converter of claim 7, wherein:
the voltage sensing circuit comprises a voltage divider circuit coupled in parallel to the storage capacitor;
the voltage divider circuit comprises a sense node that is coupled to an input terminal of the first comparator and to an input terminal of the second comparator; and
the voltage divider circuit generates the sense voltage on the sense node.

12. The power converter of claim 11, wherein the voltage divider circuit comprises a programmable voltage division ratio.

13. An intelligent electrical device comprising the power converter of claim 1, wherein the storage capacitor is configured as a direct current (DC) power source to supply DC power to control circuitry of the intelligent electrical device.

14. An intelligent solid-state circuit breaker device comprising the power converter of claim 1.

15. An intelligent solid-state light switch device comprising the power converter of claim 1.

16. A power converter, comprising:
a control system configured to control a charging of a storage capacitor using current drawn from alternating current (AC) power applied to an input terminal of the power converter, to provide direct current (DC) power to a load that is coupled to an output terminal of the power converter;
wherein the control system is configured to control the charging of the storage capacitor by:
monitoring a voltage level across the storage capacitor;
causing charging current to flow to the storage capacitor during a given positive half-cycle of the AC power to charge the storage capacitor to a maximum voltage level, in response to determining that the monitored voltage level across the storage capacitor is less than a minimum voltage level; and
preventing charging current from flowing to the storage capacitor during the given positive half-cycle of the AC power, in response to determining that the monitored voltage level across the storage capacitor is less than the maximum voltage level and greater than the minimum voltage level.

17. The power converter of claim 16, wherein the control system is further configured to control the charging of the storage capacitor by preventing charging current to flow to the storage capacitor during negative half-cycles of the AC power, irrespective of the monitored voltage level across the storage capacitor.

18. An intelligent electrical device comprising the power converter of claim 16, wherein the DC power is utilized to power control circuitry of the intelligent electrical device.

19. A method, comprising:
converting alternating current (AC) power to direct current (DC) power which is stored on a storage capacitor, wherein converting the AC power to DC power comprises:
monitoring a voltage level across the storage capacitor;
causing charging current to flow to the storage capacitor during a given positive half-cycle of the AC power to charge the storage capacitor to a maximum voltage level, in response to determining that the monitored voltage level across the storage capacitor is less than a minimum voltage level; and
preventing charging current to flow to the storage capacitor during the given positive half-cycle of the AC power, in response to determining that the monitored voltage level across the storage capacitor is less than the maximum voltage level and greater than the minimum voltage level.

20. The method of claim 19, further comprising preventing charging current to flow to the storage capacitor during negative half-cycles of the AC power, irrespective of the monitored voltage level across the storage capacitor.
